(19) United States
(12) Patent Application Publication
(10) Pub. No.: US 2026/0063906 A1
(43) Pub. Date: Mar. 5, 2026

(54) DISPLAY APPARATUS AND DISPLAY SYSTEM

(71) Applicant: CANON KABUSHIKI KAISHA, Tokyo (JP)

(72) Inventor: Tomohisa AIDA, Tochigi (JP)

(21) Appl. No.: 19/305,839

(22) Filed: Aug. 21, 2025

(30) Foreign Application Priority Data
Aug. 29, 2024 (JP) 2024-147153

(51) Int. Cl. G02B 27/01; G02B 27/28

(52) U.S. Cl. CPC G02B 27/0172; G02B 27/0176; G02B 27/285; G02B 2027/0161; G02B 2027/0178

(57) ABSTRACT

A display apparatus includes a light source, a display element configured to modulate illumination light from the light source to generate image light, and an optical system including an optical function unit configured to guide the illumination light to the display element and guide the image light to a projection side. In a first direction parallel to an effective modulation area of the display element, a width of the optical function unit is smaller than or equal to a width of the effective modulation area.

### BACKGROUND

### Field of the Technology

The aspect of the disclosure relates to one or more embodiments of a display apparatus including a head-mounted display (HMD) and smart glasses such as augmented reality (AR) glasses.

### Description of the Related Art

As a display apparatus that guides illumination light from a light source to a display element and projects image light from the display element, U.S. Pat. No. 8,300,159 discloses an apparatus having an optical system that uses a polarization beam splitter, and U.S. Pat. No. 11,256,093 discloses an apparatus having an optical system that forms a round-trip optical path.

### SUMMARY

One or more embodiments of a display apparatus according to one or more aspects of the disclosure may include a light source, a display element configured to modulate illumination light from the light source to generate image light, and an optical system including an optical function unit configured to guide the illumination light to the display element and guide the image light to a projection side. In a first direction parallel to an effective modulation area of the display element, a width of the optical function unit is smaller than or equal to a width of the effective modulation area.

One or more embodiments of a display apparatus according to one or more aspects of the disclosure may include a light source, a display element configured to modulate illumination light from the light source and generate image light, and an optical system including an optical function unit configured to guide the illumination light to the display element and guide the image light to a projection side, and an optical element having positive refractive power disposed closer to the display element than the optical function unit. In a first direction parallel to an effective modulation area of the display element, a width of the optical function unit is smaller than a width of the optical element.

One or more display systems may include the above one or more display apparatuses in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of a display apparatus according to Example 1.

FIGS. 2A and 2B illustrate the effects of Example 1.

FIG. 3 illustrates the configuration of a display apparatus according to Example 2.

FIG. 4 illustrates the configuration of a display apparatus according to Example 3.

FIG. 5 illustrates the configuration of a display apparatus according to Example 4.

FIG. 6 illustrates the configuration of a display apparatus according to a variation of Example 4.

FIG. 7 illustrates the configuration of a display apparatus according to the variation of Example 4.

FIG. 8 illustrates the configuration of a display apparatus according to Example 5.

FIG. 9 illustrates the configuration of a display apparatus according to a variation of Example 5.

FIG. 10 illustrates the configuration of a light source unit according to Example 3.

FIG. 11 illustrates the configuration of the polarization conversion element in the light source unit illustrated in FIG. 10.

FIG. 12 illustrates another configuration of the light source unit in Example 3.

FIG. 13 illustrates the configuration of a display system according to Example 6.

FIG. 14 illustrates the configuration of a display apparatus in the display system according to Example 6.

FIG. 15 illustrates another configuration of the display apparatus in the display system according to Example 6.

FIGS. 16A, 16B, 16C, and 16D illustrate the configurations of an optical function unit.

FIG. 17 illustrates the configuration of an on-board (in-vehicle) display system according to Example 7.

FIG. 18 illustrates the configuration of a projector according to Example 8.

### DESCRIPTION OF THE EMBODIMENTS

Referring now to the accompanying drawings, a description will be given according to Examples according to the disclosure.

### Example 1

FIG. 1 illustrates the configuration (YZ cross section) of a display apparatus 100a according to Example 1. The display apparatus 100a is disposed on the head (in front of the face) of an observer as an HMD or smart glasses, as described later, or is used for an on-board (in-vehicle) display system or a projector.

Illumination light emitted from a light source unit 1 of a display apparatus 100a is guided to a display element 30 via an optical function unit 20 disposed in the projection optical system 10 and a positive lens 40a which is a part of the optical element of the projection optical system 10. In FIG. 1, a Z direction is a direction in which the optical axis of the projection optical system 10 extends, a direction orthogonal to the optical axis in the YZ cross section as a first cross section including the optical axis and the normal line of the surface on which the optical function unit 20 is provided is a Y direction, and a direction orthogonal to the Z direction and the Y direction is an X direction. The optical function unit 20 may be configured to guide the illumination light to the display element and guide the image light to a projection side.

The display element 30 includes a reflective liquid crystal element (LCOS: Liquid crystal on silicon). The reflective liquid crystal element is an element that modulates and reflects incident light according to the orientation direction of the liquid crystal.

The optical function unit 20 includes a polarization beam splitter (PBS) held between two prisms. The polarization beam splitter is an element that reflects or transmits incident light according to the polarization state of the light. The two prisms and the polarization beam splitter surface disposed between them are sometimes collectively referred to as the polarization beam splitter, but the optical function unit 20 in this embodiment corresponds to the polarization beam splitter surface. In other words, the optical function unit is a part that actually has the function of reflecting and transmitting light, and does not include another part.

The linearly polarized light (S-polarized light) as the illumination light emitted from the light source unit 1 is deflected toward the display element 30 by being reflected by the optical function unit 20, and transmits through the positive lens 40a to enter the display element 30. The illumination light that enters the display element 30 is modulated according to the original image formed (displayed) on the modulation surface of the display element 30. Thereby, image light is generated. At this time, the image light is phase-modulated by the liquid crystal and is output from the display element 30 as P-polarized light.

The image light from the display element 30 is converged after transmitting through the positive lens 40a, transmits through the optical function unit 20, and further transmits through a lens unit 40b consisting of a plurality of lenses in the projection optical system 10 to reach the pupil (exit pupil) P on the projection side. Thus, the image light is projected onto the observer's eye located at the position of the pupil P (hereinafter referred to as the pupil position) or onto a light guide element described later. The positive lens 40a is located closest to the display element in the projection optical system 11 and has the largest outer diameter.

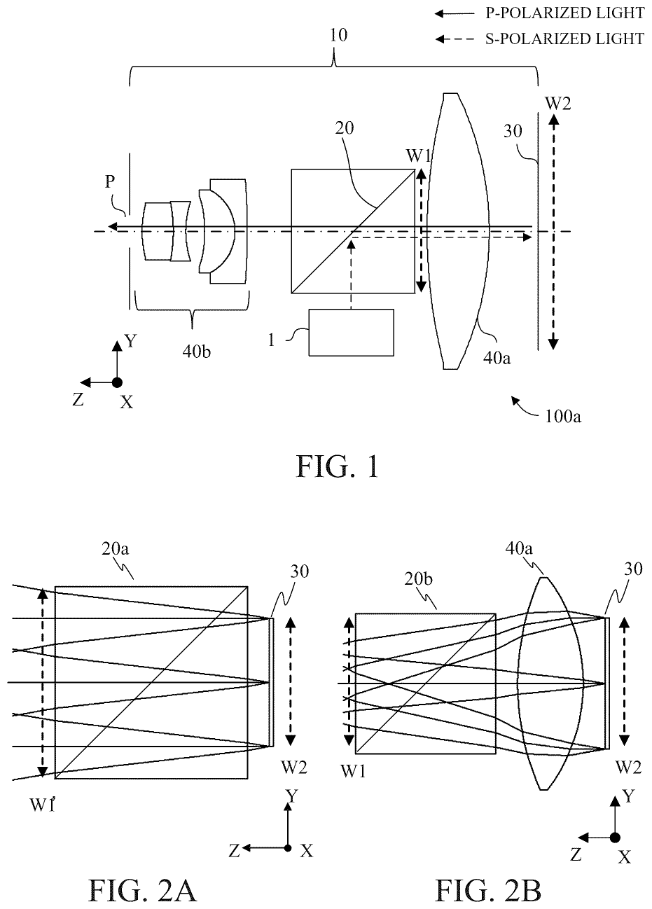

Referring now to FIGS. 2A and 2B, a description will be given of the function of the positive lens 40a located between the optical function unit 20 and the display element 30. FIGS. 2A and 2B illustrate the first cross section (YZ cross section). The first cross section is also a cross section parallel to the first side of the effective modulation area that modulates light according to an original image on a modulation surface (display surface) of the display element 30. In the following description, a direction parallel to the first side (Y direction) will be referred to as a first direction. The effective modulation area of the display element 30 is a rectangle with an aspect ratio of 16:9, 4:3, etc., and in this example, the first side is the short side of the effective modulation area. However, the first side may be the long side of the effective modulation area.

The display element 30 emits a divergent light beam (F-number light beam) in a predetermined angular range. As illustrated in FIG. 2A, in a case where the optical function unit 20a and the display element 30 are arranged close to each other without the positive lens 40a, a width W1′ of the optical function unit 20a in the first direction is larger than a width (length of the short side) W2 of the effective modulation area of the display element 30 in the first direction (W1′>W2). A distance between the display element 30 and the lens unit 40b disposed on the pupil side (projection side) of the optical function unit 20a increases, so that both the overall length of the projection optical system and the outer diameter of the lens unit disposed closest to the display element (optical function unit) increase.

On the other hand, by placing a positive lens 40a between the optical function unit 20 and the display element 30 as illustrated in FIG. 2B, the divergent light beam emitted from the display element 30 can be converged and introduced into the optical function unit 20. Therefore, the width W1 of the optical function unit 20 in the first direction can be smaller than W1′ in the case of FIG. 2A, and more specifically, can be equal to or smaller than W2 (W1<W2) as illustrated in FIG. 1. In other words, the size of the optical function unit 20 can be reduced. In addition, as illustrated in FIG. 1, the outer diameter of the lens unit 40b disposed on the pupil side of the optical function unit 20 and the overall length of the projection optical system 10 can be reduced. In addition, by placing the first cross section of the optical function unit 20 so that it is parallel to the short side as the first side of the display element, the size of the optical function unit 20 can be further reduced. Thereby, the size of the entire display apparatus can be reduced. Moreover, the positive lens 40a can introduce a principal ray of the illumination light into a variety of positions of the display element 30 ideally incident almost perpendicularly on the display element 30.

As described above, the optical function unit according to this example is a unit that actually has the functions of reflecting and transmitting light, and its width in the first direction is not the width in the first direction of the prism that holds the optical function unit. In other words, even if the prism is larger than the optical function unit in the first direction or has a held portion that is held by a housing (lens barrel) and the width of the prism is larger than W1, the width of the optical function unit in the first direction is W1.

As long as the optical element disposed between the optical function unit 20 and the display element 30 has the function of converging a light beam (deflecting a principal ray toward the optical axis), it may be a biconvex lens as illustrated in FIG. 2B, a plano-convex lens, or a meniscus lens. It may use a diffractive optical element, a meta-optical element, or a computer generated hologram (CGH) element, which controls the wavefront by a microstructure, or a holographic optical element.

In this and other example described later, at least one of the following inequalities (1) to (4) may be satisfied.

The width W1 of the optical function unit 20 in the first direction and the width W2 of the effective modulation area of the display element 30 in the first direction may satisfy the following inequality:

$$0 < W 1 / W 2 \leq 1. \qquad ( 1 )$$

By reducing the size of the optical function unit 20 so as to satisfy this inequality, the sizes of the projection optical system 10 and the display apparatus can also be reduced. The upper limit value of inequality (1) may be 0.9, 0.8, 0.7, 0.6, 0.5, or 0.4.

The following inequality may be satisfied:

$$0 < L 1 / L 2 \leq 0.7 \qquad ( 2 )$$

where L1 is a distance on the optical axis from a pupil position of the projection optical system 10 to the optical function unit 20, and L2 is a distance on the optical axis from the pupil position to (the modulation surface of) the display element 30.

Satisfying this inequality can reduce the size of the optical function unit 20. As in Examples 4 to 6 described below, the “distance on the optical axis” in a case where the image light from the display element 30 reaches the pupil P after being reflected by the optical function unit 20 or other reflecting surfaces, corresponds to a distance along the central ray that is emitted from the center of the effective modulation area of the display element, is reflected, and reaches the center of the pupil P. The upper limit value of inequality (2) may be set to 0.6, 0.5, 0.4, 0.3, 0.2, or 0.1.

The following inequality may be satisfied:

$$1. \leq L 2 / H \leq 4. \qquad ( 3 )$$

where H is a diagonal length of the effective modulation area of the display element 30.

Satisfying this inequality can further reduce the size of the projection optical system 10. The upper limit value of inequality (3) may be set to 3.0 or 2.0.

The following inequality may be satisfied:

$$ff / f \leq 2.5 \qquad ( 4 )$$

where ff is a focal length of an optical element having refractive power disposed closest to the display element in the projection optical system 10, and f is a focal length of the projection optical system 10.

Satisfying this inequality can reduce the size of the projection optical system 10. In a case where the value of ff/f is too small, it may be difficult to correct aberrations, so the following inequality may be satisfied:

$$0.3 \leq ff / f \leq 2.5 \qquad ( 4 a )$$

The upper limit value of inequality (4) may be set to 2.0, 1.5, or 1.0.

A flat element having no refractive power, such as a cover glass, a waveplate, or a phase compensation plate, may be disposed between the display element 30 and the positive lens 40a. Attaching dust to the cover glass instead of the modulation surface of the display element 30 can prevent an image of the dust from appearing clearly at the pupil position. In addition, by disposing a wavelength plate or a phase compensation plate, the contrast and quality of the image displayed by the image light can be improved.

In this example, since most of the image light obliquely enters the optical function unit (polarization beam splitter) 20 as illustrated in FIG. 2B, an element with low incidence angle dependency may be used for the optical function unit 20. More specifically, a wire grid polarizer or a dielectric or film with 100 or more layers of films may be used.

In order to change the polarization state of the linearly polarized light emitted from the projection optical system 10 to the pupil P, a polarizing element such as a half waveplate may be disposed on the pupil side of the optical function unit 20. At this time, the half waveplate may be disposed by adhering it to a light transmitting substrate (flat plate) that holds it, or may be bonded to an optical element in the projection optical system by adhesive or the like.

### Example 2

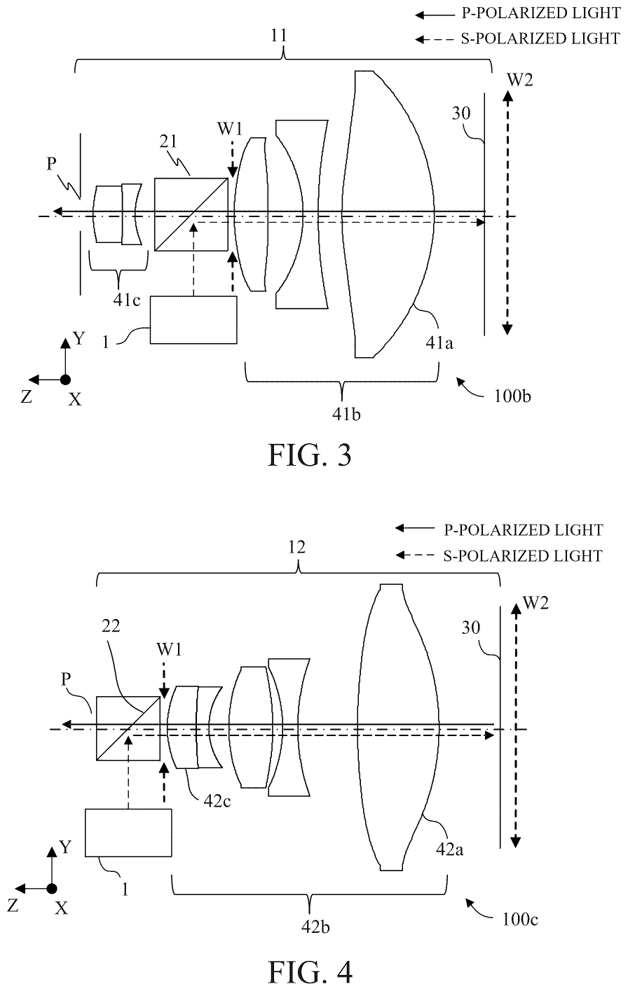

FIG. 3 illustrates the configuration (YZ cross section) of a display apparatus 100b according to Example 2. The display apparatus 100b according to this example differs from that of Example 1 in the arrangement of the optical function unit 21 in the projection optical system 11. More specifically, a lens unit 41b including a plurality of lenses is disposed between the display element 30 and the optical function unit 21. A positive lens 41a, which has the largest outer diameter in the projection optical system 11, is disposed on the display element side of the lens unit 41b. A lens unit 41c including a plurality of lenses is disposed on the pupil side of the optical function unit 21.

Due to this configuration, compared to Example 1, the optical function unit 21 is disposed at a position where the image light converges to have a smaller light beam diameter, so that the size of the optical function unit 21 can be reduced so that the width W1 in the first direction is smaller. The outer diameter of the lens unit 40c and the overall length of the projection optical system 11 can be reduced.

### Example 3

FIG. 4 illustrates the configuration (YZ cross section) of a display apparatus 100c according to Example 3. The display apparatus 100c according to this example differs from that of each of Examples 1 and 2 in the arrangement of the optical function unit 22 in the projection optical system 12. More specifically, the optical function unit 22 is disposed on the pupil side of the projection optical system 12. A lens unit 42b including of a plurality of lenses is disposed between the display element 30 and the optical function unit 22. A positive lens 42a having the largest outer diameter (width in the first direction) in the projection optical system 12 is disposed on the pupil side of the lens unit 42b. A lens 42c having the smallest outer diameter (width in the first direction) in the projection optical system 12 is disposed on the pupil side of the lens unit 42b. In the first direction, the width W1 of the optical function unit 22 is smaller than the width of the lens 42c.

Due to this configuration, the optical function unit 22 is disposed at a position where the image light converges to have the smallest light beam diameter in the projection optical system 12, so that the optical function unit 22 can be made even smaller in width W1 in the first direction than that in each of Examples 1 and 2. Thus, the overall length of the projection optical system 11 can be smaller.

### Example 4

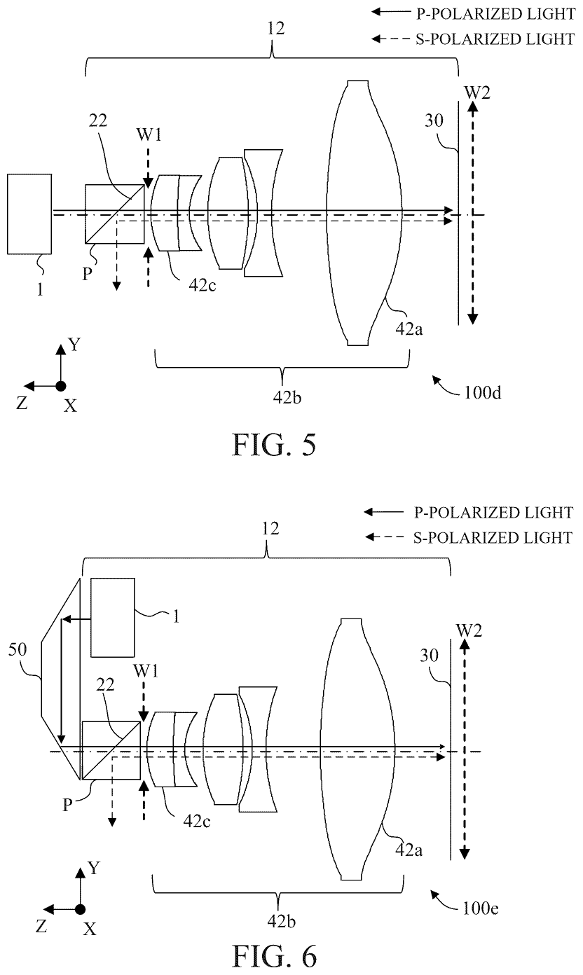

FIG. 5 illustrates the configuration (YZ cross section) of a display apparatus 100d according to Example 4. The display apparatus 100d according to this example differs from that of Example 3 in the arrangement of the light source unit 1. In this embodiment, those elements, which are corresponding elements in Example 3, will be designated by the same reference numerals as those of Example 3.

In this example, the illumination light (P polarized light) emitted from the light source unit 1 and incident on the projection optical system 12 transmits through the optical function unit 22, transmits through the lens unit 42b, and enters the display element 30. On the other hand, the image light (S-polarized light) emitted from the display element 30 transmits through the lens unit 42b, is reflected and deflected by the optical function unit 22, and reaches the pupil P.

Thus, changing the position of the light source unit 1 relative to that of Example 3 can change a direction in which the image light is emitted (the orientation of the pupil P). In a case where the image light that reaches the pupil P is S-polarized, a half waveplate may be provided on the pupil side of the optical function unit 22 in the configuration according to Example 3, but the half waveplate may not be provided in this example.

As in the display apparatus 100e according to a variation illustrated in FIG. 6, an optical deflecting element 50 may be disposed in the optical path from the light source unit 1 to the optical function unit 22. The optical deflecting element 50 reflects (deflects) the illumination light emitted from the light source unit 1 twice and makes it incident on the optical function unit 22. Due to this configuration, the light source unit 1 and the optical function unit 22 can be disposed in parallel in the Y direction. The optical deflecting element 50 may be an integrated optical element having two reflecting surfaces, or may include only two reflective surfaces (mirrors).

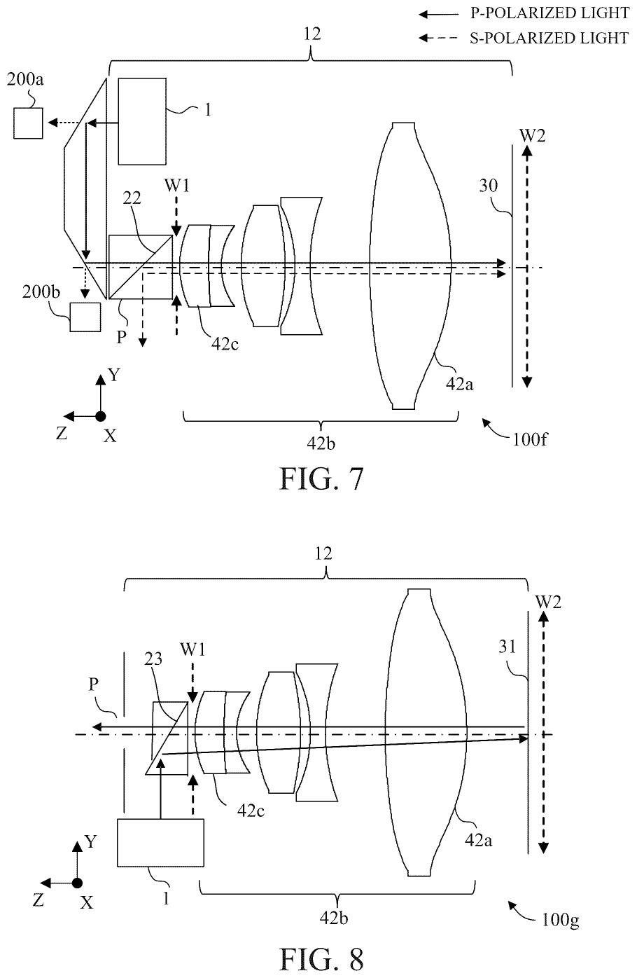

As illustrated in FIG. 7, as in a display apparatus 100f according to another variation, an area through which part of the illumination light can transmit may be provided on a part of each of the two reflective surfaces of the optical deflecting element 50, and light receivers 200a and 200b may be provided to receive the illumination light that transmits through the area. Thereby, the amount and color of the illumination light can be measured and the light source unit 1 can be controlled based on the measurement result, thereby the brightness and color of the displayed image can be adjusted.

### Example 5

FIG. 8 illustrates the configuration (YZ cross section) of a display apparatus 100g according to Example 5. In the display apparatus 100g according to this example, the configurations of a display element 31 and the optical function unit 23 are different from those of the display element 30 and the optical function unit 22 according to Example 3. Those elements in this example, which are corresponding elements in Example 3, will be designated by the same reference numerals as those of Example 3.

The display element 31 according to this example includes a mirror element (digital micromirror device: DMD) in which minute movable mirrors are arranged two-dimensionally. The DMD generates image light by controlling a direction in which the illumination light is reflected by switching the tilt (turning-on and turning-off) of the movable mirrors that constitute each pixel. In this case, the principal ray of the illumination light is incident from a direction tilted relative to the normal to the modulation surface (the surface on which the movable mirrors are arranged) of the display element 31, and the principal ray of the image light is deflected in a direction parallel to the normal. In a case where such a DMD is used, the illumination light may be unpolarized light.

The optical function unit 23 includes a Total Internal Reflection (TIR) prism in which two right-angle prisms (entrance prism 23a and exit prism 23b) have tilted surfaces that are acuter than 45° relative to a plane orthogonal to the optical axis, with the tilted surfaces facing each other via an air gap. The illumination light incident on the entrance prism 23a from the light source unit 1 is totally reflected at the interface between the tilted surface and the air gap and deflected toward the display element. As described above, the tilted surface of the entrance prism 23a forms an angle more acute than 45° relative to the plane orthogonal to the optical axis. Thus, the principal ray of the illumination light incident on the entrance prism 23a from a direction perpendicular to the optical axis and totally reflected by the tilted surface enters the display element (DMD) 31 from a direction tilted relative to the normal to the modulation surface via the lens unit 42b.

The principal ray of the image light reflected by the display element 31 exits in a direction parallel to the normal to the modulation surface and enters the entrance prism 23a via the lens unit 42b. At this time, the principal ray of the image light enters the tilted surface of the entrance prism 23a at an angle different from the incident angle at which it is totally reflected, so it transmits through the tilted surface without being totally reflected, and then transmits through the exit prism 23b to reach the pupil P.

In this example, the width of the optical function unit 23 in the first direction is the width in the first direction of the tilted surface that totally reflects the illumination light in the entrance prism 23a and transmits the image light.

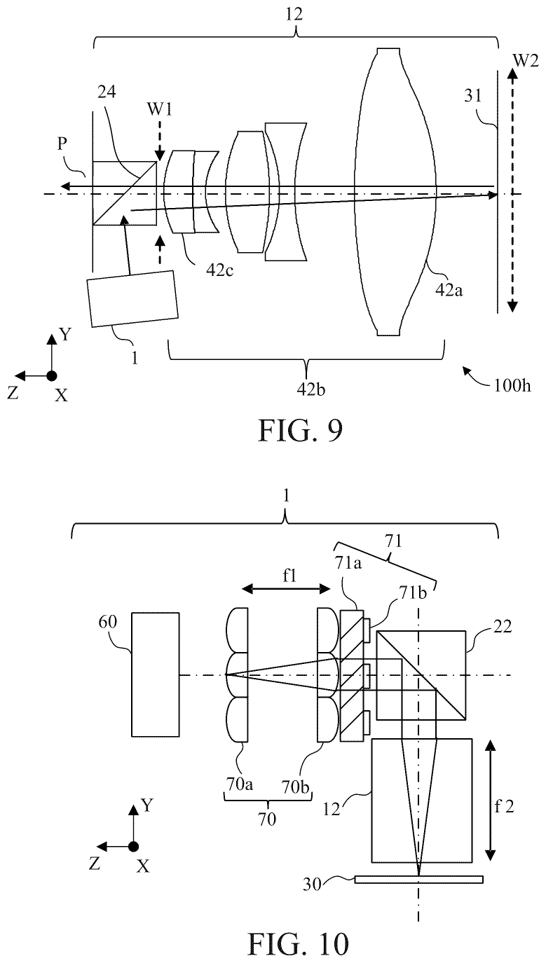

As in the display apparatus 100h according to a variation illustrated in FIG. 9, a tilt angle of the optical function unit 24 may be set to 45° by utilizing the angle dependency of a dielectric layer provided as the optical function unit 24 between two prisms and tilted relative to a plane orthogonal to the optical axis. More specifically, the principal ray of the illumination light from the light source unit 1 is tilted from the plane orthogonal to the optical axis and enters the dielectric layer tilted at 45° relative to the optical axis. The dielectric layer reflects the illumination light toward the display element and transmits the image light, as in FIG. 8. The width of the optical function unit 24 in the first direction is the width of the dielectric layer in the same direction.

According to this example, even when a DMD is used as the display element, the optical function unit 24 can be smaller, and the overall length of the projection optical system 12 can be reduced.

Numerical examples 1 to 3 corresponding to Examples 1 to 3, respectively, will be illustrated below. In each numerical example, a surface number i indicates the order of the surface counted from the pupil side. A first surface is a pupil plane where the pupil P is located. r represents a radius of curvature (mm) of an i-th surface from the pupil side, d is a lens thickness or air gap (mm) on the optical axis between i-th and (i+1)-th surfaces, and nd represents a refractive index for the d-line of the optical material between i-th and (i+1)-th surfaces. νd is an Abbe number based on the d-line of the optical material between i-th and (i+1)-th surfaces.

The Abbe number νd based on the d-line is expressed as:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer lines.

An effective diameter is a radius (mm) of an area of an i-th lens surface through which light rays that contribute to imaging pass.

BF represents back focus (mm). The back focus is a distance on the optical axis from the surface of the projection optical system closest to the display element (final surface) to the modulation surface of the display element, expressed in air-equivalent length. An overall lens length is a distance on the optical axis from the pupil position of the projection optical system to the final surface plus the back focus.

An asterisk “*” next to a surface number means that the surface has an aspheric shape. The aspheric shape is expressed by the following equation:

$$x = ( {h}^{2} / R ) / [ 1 + √ \{ 1 - ( 1 + k ) {( h / R )}^{2} \} ] + A 4 \times {h}^{4} + A 6 \times {h}^{6} + A 8 \times {h}^{8}$$

where x is a displacement amount from a surface vertex in the optical axis direction (Z direction), h is a height from the optical axis in a direction orthogonal to the optical axis, a light traveling direction is positive, R is a paraxial radius of curvature, K is a conic constant, and A4, A6, and A8 are aspheric coefficients.

The “e±M” in the conic constant and aspheric coefficient means×10^{±M}. (P) represents a pupil. MS represents a modulation surface.

Table 1 summarizes values corresponding to inequalities (1) to (4) in numerical examples 1 to 3.

### Numerical Example 1

UNIT: mm

SURFACE DATA

| Surface | | | | | Effective |
|---|---|---|---|---|---|
| No. | r | d | nd | νd | Diameter |
| 1(P) | ∞ | 0.50 | | | 1.30 |
| 2 | 4.216 | 1.26 | 2.05090 | 26.9 | 1.87 |
| 3 | −5.704 | 0.50 | 1.80810 | 22.8 | 2.04 |
| 4 | 3.590 | 0.77 | | | 2.14 |
| 5* | −5.646 | 1.22 | 1.85135 | 40.1 | 2.52 |
| 6 | −1.863 | 0.50 | 1.72825 | 28.5 | 3.00 |
| 7 | −25.475 | 1.77 | | | 3.79 |
| 8 | ∞ | 5.00 | 2.00100 | 29.1 | 5.84 |
| 9 | ∞ | 0.49 | | | 8.35 |
| 10 | 21.220 | 2.51 | 1.75500 | 52.3 | 9.50 |
| 11 | −12.415 | 1.99 | | | 9.82 |
| MS | ∞ | | | | |

### Aspheric Data

5th Surface
K=8.99977e+00 A 4=−1.14776e−03 A 6=−2.79821e−04

VARIOUS DATA
ZOOM RATIO 1.00

| | |
|---|---|
| Focal Length | 10.44 |
| Fno | 8.00 |
| Half Angle of View (°) | 24.44 |
| Image Height | 4.74 |
| Overall Lens Length | 16.51 |
| BF | 1.99 |
| d11 | 1.99 |

LENS UNIT DATA

| | | | Lens | Front | Rear |
|---|---|---|---|---|---|
| Lens | Starting | Focal | Construction | Principal-Point | Principal-Point |
| Unit | Surface | Length | Length | Position | Position |
| 1 | 1 | 10.44 | 14.53 | 8.23 | −8.45 |

SINGLE LENS DATA

| Lens | Starting Surface | Focal Length |
|---|---|---|
| 1 | 1 | 2.47 |
| 2 | 3 | −2.66 |
| 3 | 5 | 2.84 |
| 4 | 6 | −2.78 |
| 5 | 8 | 0.00 |
| 6 | 10 | 10.72 |

### Numerical Example 2

UNIT: mm

SURFACE DATA

| Surface | | | | | Effective |
|---|---|---|---|---|---|
| No. | r | d | nd | νd | Diameter |
| 1(P) | ∞ | 0.50 | | | 1.29 |
| 2 | 3.861 | 1.17 | 2.00100 | 29.1 | 1.88 |
| 3 | −22.115 | 0.50 | 1.80810 | 22.8 | 2.04 |
| 4 | 2.813 | 0.77 | | | 2.15 |
| 5 | ∞ | 3.00 | 2.00100 | 29.1 | 2.88 |
| 6 | ∞ | 0.15 | | | 4.58 |
| 7* | 6.667 | 1.33 | 1.88202 | 37.2 | 5.41 |
| 8* | 70.551 | 1.40 | | | 5.43 |
| 9 | −5.040 | 0.60 | 1.80810 | 22.8 | 5.53 |
| 10 | 17.945 | 0.94 | | | 6.64 |
| 11* | 9.781 | 3.65 | 1.88202 | 37.2 | 9.15 |
| 12 | −7.713 | 2.00 | | | 10.06 |
| MS | ∞ | | | | |

### Aspheric Data

7th Surface
K=0.00000e+00 A 4=−7.33908e−03 A 6=9.60556e−04 A 8=−2.39833e−05

### 8th Surface

K=0.00000e+00 A 4=−9.74705e−03 A 6=8.90716e−04

### 11th Surface

K=0.00000e+00 A 4=−3.09581e−03 A 6=1.17792e−04 A 8=−1.93166e−06

VARIOUS DATA
ZOOM RATIO 1.00

| | |
|---|---|
| Focal Length | 10.34 |
| Fno | 8.00 |
| Half Angle of View (°) | 24.64 |
| Image Height | 4.74 |
| Overall Lens Length | 16.00 |
| BF | 2.00 |
| d12 | 2.00 |

LENS UNIT DATA

| | | | Lens | Front | Rear |
|---|---|---|---|---|---|
| Lens | Starting | Focal | Construction | Principal-Point | Principal-Point |
| Unit | Surface | Length | Length | Position | Position |
| 1 | 1 | 10.34 | 14.00 | 10.24 | −8.35 |

SINGLE LENS DATA

| Lens | Starting Surface | Focal Length |
|---|---|---|
| 1 | 1 | 3.36 |
| 2 | 3 | −3.06 |
| 3 | 5 | 0.00 |
| 4 | 7 | 8.27 |
| 5 | 9 | −4.81 |
| 6 | 11 | 5.42 |

### Numerical Example 3

UNIT: mm

SURFACE DATA

| Surface | | | | | Effective |
|---|---|---|---|---|---|
| No. | r | d | nd | νd | Diameter |
| 1(P) | ∞ | 0.00 | | | 1.27 |
| 2 | ∞ | 2.50 | 2.00100 | 29.1 | 1.27 |
| 3 | ∞ | 0.30 | | | 2.36 |
| 4 | 3.688 | 1.15 | 2.00100 | 29.1 | 2.93 |
| 5 | 16.823 | 0.50 | 1.80810 | 22.8 | 2.89 |
| 6 | 2.636 | 0.79 | | | 2.86 |
| 7* | 5.936 | 1.74 | 1.88202 | 37.2 | 4.11 |
| 8* | −9.268 | 0.40 | | | 4.30 |
| 9 | −5.256 | 0.60 | 1.80810 | 22.8 | 4.30 |
| 10 | 7.880 | 2.36 | | | 4.85 |
| 11* | 20.227 | 3.23 | 1.88202 | 37.2 | 9.71 |
| 12* | −9.467 | 2.43 | | | 10.02 |
| MS | ∞ | | | | |

### Aspheric Data

### 7th Surface

K=0.00000€+00 A 4=−2.04769e−04 A 6=4.14667e−04 A 8=−1.57795e−05

### 8th Surface

K=0.00000c+00 A 4=−2.95488e−04 A 6=1.48283e−04

### 11th Surface

K=0.00000€+00 A 4=−4.90803e−04 A 6=2.84211e−05 A 8=−1.756740-07

### 12th Surface

K=0.00000€+00 A 4=−2.94312e−04 A 6=−3.05013e−06 A 8-7.95497e−07

VARIOUS DATA
ZOOM RATIO 1.00

| | |
|---|---|
| Focal Length | 10.19 |
| Fno | 8.00 |
| Half Angle of View (°) | 24.97 |
| Image Height | 4.74 |
| Overall Lens Length | 16.00 |
| BF | 2.43 |
| d12 | 2.43 |

LENS UNIT DATA

| | | | Lens | Front | Rear |
|---|---|---|---|---|---|
| Lens | Starting | Focal | Construction | Principal-Point | Principal-Point |
| Unit | Surface | Length | Length | Position | Position |
| 1 | 1 | 10.19 | 13.57 | 7.87 | −7.76 |

SINGLE LENS DATA

| Lens | Starting Surface | Focal Length |
|---|---|---|
| 1 | 1 | 0.00 |
| 2 | 4 | 4.52 |
| 3 | 5 | −3.93 |
| 4 | 7 | 4.34 |
| 5 | 9 | −3.82 |
| 6 | 11 | 7.70 |

TABLE 1

| | Numerical | Numerical | Numerical |
|---|---|---|---|
| Inequality | Example 1 | Example 2 | Example 3 |
| (1) W1/W2 | 0.397 | 0.568 | 0.893 |
| (2) L1/L2 | 0.078 | 0.278 | 0.546 |
| (3) L2/H | 1.686 | 1.686 | 1.740 |
| (4) ff/f | 0.756 | 0.524 | 1.027 |

### Configuration of Light Source Unit 1

The configuration of the light source unit 1 will be described using FIGS. 10, 11, and 12. FIG. 10 illustrates the configuration (YZ cross section) of the light source unit 1 in the display apparatus according to Example 3. The light beam emitted from a light emitter 60 is split by a first fly's eye lens 70a, and each split light beam is condensed near a second fly's eye lens 70b to form a light source image.

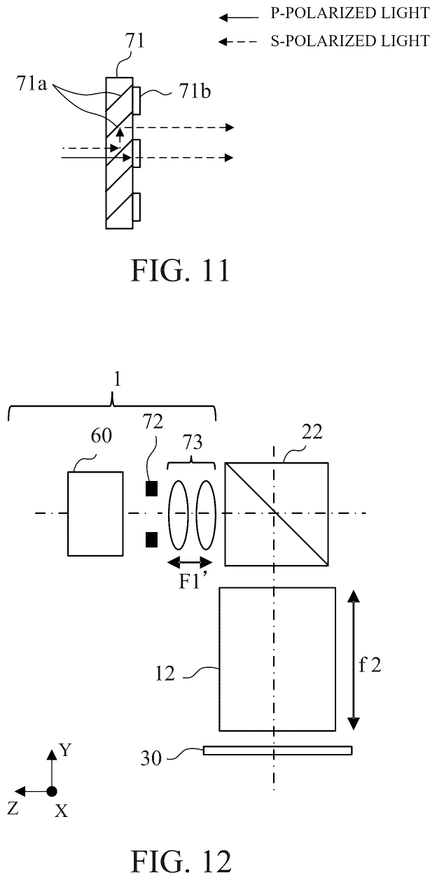

In a case where the light emitter 60 emits nonpolarized light such as an LED, a polarization conversion element 71 is provided near the second fly's eye lens 70b. The polarization conversion element 71 is an element in which a PBS 71a and a half waveplate 71b are alternately arranged, and converts the incident nonpolarized light into linearly polarized light (S-polarized light) in a specific polarization direction. More specifically, as illustrated in FIG. 11, S-polarized light among the incident nonpolarized light is reflected by the two PBSs 71a and emitted, and P-polarized light transmitted through the PBSs 71a is converted to S-polarized light by a half waveplate 71b and emitted. The S-polarized light emitted as illumination light from the polarization conversion element 71 enters the projection optical system 12, is reflected by the optical function unit 22, and is guided to the display element 30. In a case where the light emitter 60 emits linearly polarized light such as a laser, the polarization conversion element 71 is not necessary. In this case, as illustrated in FIG. 12, the light source unit 1 can include the light emitter 60, a mask 72 as a light shielding member having an opening similar in shape to that of the display element 30, and an illumination lens 73. The mask 72 and the display element 30 are optically conjugate. The illumination lens 73 and the projection optical system 12 are arranged in tandem, and the magnification is determined by a ratio of a focal length F1′ of the illumination lens 73 to a focal length f2 of the projection optical system 12. Since laser light has high directivity, light with a narrow beam diameter (dark Fno) can be effectively used. Thus, a very small display apparatus can be achieved.

### Example 6

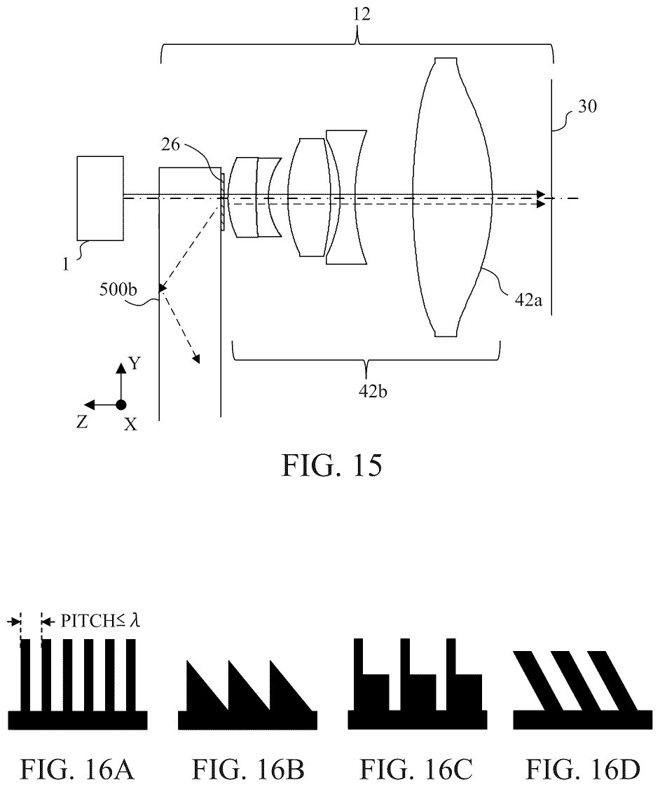

FIGS. 16A, 16B, 16C, and 16D illustrate the configuration of a display system (HMD or smart glasses) according to Example 6, which includes the display apparatuses according to Examples 1 to 5. FIGS. 14 and 15 illustrate the configuration in a case where the display apparatus 100c according to Example 3 is used in the display system according to this example.

A frame 700 holds a display optical system 500 disposed in front of each of the right and left eyes of the observer 1000, and one of the display apparatuses according to Examples 1 to 5 for the right and left eyes, respectively. The pupil of the projection optical system in the display apparatus coincides with the entrance unit of the display optical system 500. Referring now to FIG. 14, a description will be given of a case where the display apparatus according to Example 3 provided for the right eye and the display optical system 500 guide image light to the observer's right eye. The display apparatus and display optical system 500 provided for the left eye similarly guide image light to the left eye.

The display apparatus for the right eye includes, in its projection optical system 12, a lens unit 42b including a positive lens 42a, and an entrance unit of a light guide element 500a constituting the display optical system 500. The entrance unit of the light guide element 500a includes an optical function unit 25 corresponding to the optical function unit 22 illustrated in FIG. 4. The light guide element 500a has a first surface and a second surface that face each other.

The optical function unit 25 transmits illumination light from the light source unit 1 toward the display element 30, and reflects image light incident from the display element 30 toward the first surface of the light guide element 500a. The image light incident on the first surface is totally reflected on the first surface and travels toward the second surface, and the image light totally reflected on the second surface travels toward the first surface. Thus, the image light propagates through the light guide element 500a while being totally reflected by the first and second surfaces of the light guide element 500a, and is emitted toward the right eye from an exit unit (not illustrated) provided in front of the right eye of the light guide element 500a. Thereby, the image light is guided to the right eye, and the observer can view an image formed by the image light through the right eye. A stereoscopic image can be observed by allowing the right eye and the left eye to visually recognize images having a parallax.

As illustrated in FIG. 18, an optical function unit 26 may be provided on the first surface of the light guide element 500b. The optical function unit 26 can include a diffractive optical element having a fine lattice structure with a pitch equal to or less than the wavelength 2 of the image light, as illustrated in FIGS. 16A, 16B, 16C, and 16D. The diffractive optical element has optical anisotropy according to the polarization state of the incident light. More specifically, it has the property of diffracting and polarizing S-polarized light and transmitting P-polarized light as it is. Therefore, the illumination light (P-polarized light) from the light source unit 1 transmits through the optical function unit 26 toward the display element 30, and the image light (S-polarized light) from the display element 30 is diffracted by the optical function unit 26 and deflected toward the second surface of the light guide element 500b. The image light incident on the second surface is totally reflected by the second surface and directed toward the first surface, and the image light totally reflected by the first surface is directed toward the second surface. Thus, the image light propagates through the light guide element 500b while being totally reflected by the second and first surfaces of the light guide element 500b, and is emitted toward the right eye from an exit unit (not illustrated) provided in front of the right eye of the light guide element 500b.

The optical function unit 26 is not limited to a diffractive optical element, and a holographic element having optical anisotropy according to the polarization state can also be used.

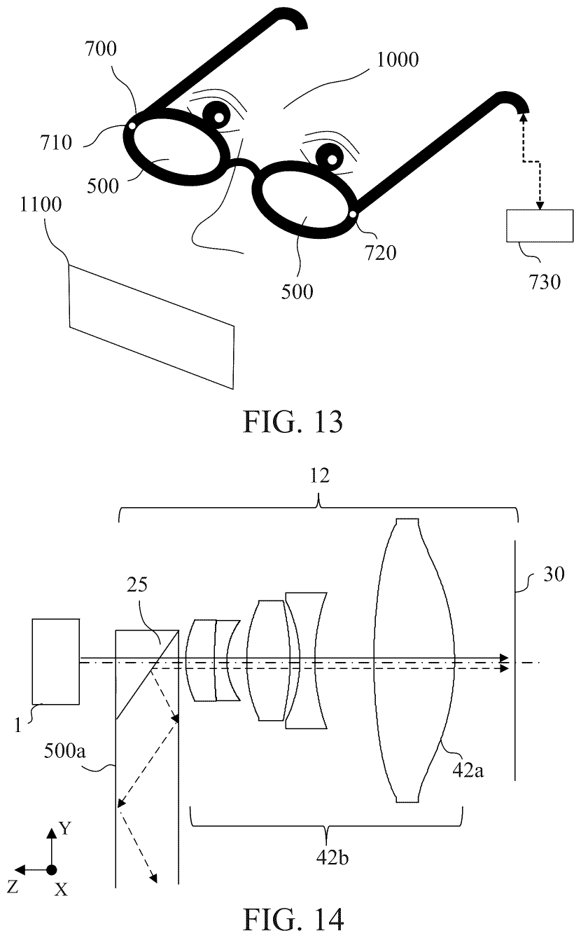

As illustrated in FIG. 13, a control unit 730 configured to control the driving of the display element 30 and the light amount of the light source unit 1 is connected to the frame 700. The control unit 730 may be disposed outside the frame 700 as illustrated in the figure and connected to the display apparatus via wired or wireless communication, or may be disposed within the frame 700.

The frame 700 is attached to a first information acquiring unit 710 including a camera that acquires pupil information indicating the position and movement (point of view or line of sight) of the pupil of the eye of the observer 1000. The control unit 730 corrects the position of the display image 1100 (the position where the original image is formed on the display element) based on the pupil information. The frame 700 is also attached to a second information acquiring unit 720 including a camera that acquires external (surrounding) information. The control unit 730 adjusts a light amount of the light source unit 1 (i.e., the luminance of the display image 1100) according to the luminance of the external world obtained from the external world information.

### Example 7

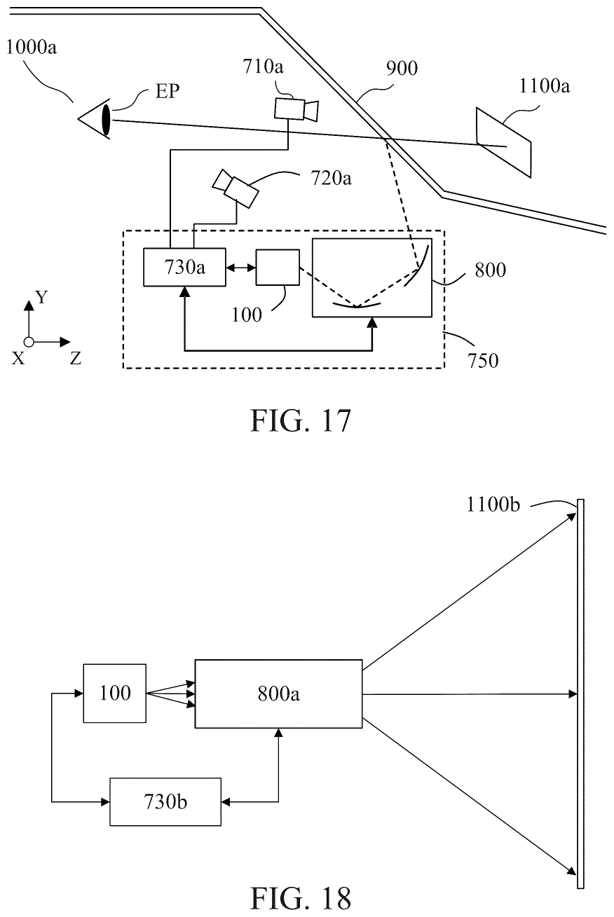

FIG. 17 illustrates the configuration of a head-up display (HUD) 750 as an on-board display system according to Example 7 using any one of the display apparatuses 100 according to Examples 1 to 5. The HUD 750 includes a projection optical system 800 separate from the projection optical system in the display apparatus 100, a first information acquiring unit 720a, a second information acquiring unit 710a, and a control unit 730a. The HUD 750 is mounted on an automobile 900 as a movable unit, and projects an image (virtual image) 1100a for supporting the user (driver or passenger) of an automobile 900 onto the windshield, which is the projection surface, via the projection optical system 800. The movable unit may be a train, a ship, an airplane, or the like, in addition to an automobile.

The first information acquiring unit 720a includes a camera that acquires pupil information indicating the position and movement (point of view or line of sight) of the user's pupil EP. The control unit 730a corrects the position of the display image 1100a (a forming position of an original image on the display element) based on the pupil information. The second information acquiring unit 710a includes a camera that acquires external world information. The control unit 730a adjusts the luminance of the display image 1100a according to the luminance of the external world obtained from the external world information, and displays the display image 1100a superimposed on the external world image obtained from the external world information. The second information acquiring unit 710a may acquire external world information not only from the front, but also from the rear, sides, etc.

The control unit 730a determines the likelihood of collision of the automobile 900 with an obstacle (object) obtained from the external world information, and in a case where there is a likelihood of collision, issues an alert or controls any one of the driving units (engine, motor, etc.), brakes, and steering of the automobile 900. The alert method includes issuing an alert sound, displaying alert information on the display screen of the car navigation system, and issuing vibrations to the seat belt or steering wheel.

### Example 8

FIG. 18 illustrates the configuration of an image projection apparatus (projector) as a display system using any one of the display apparatuses 100 according to Examples 1 to 5. The image light emitted from the display apparatus 100 is projected onto a projection surface 1100b such as a screen via a projection optical system 800a separate from the projection optical system within the display apparatus 100. Thereby, an enlarged image (real image) of the original image displayed on the display element 30 can be displayed on the projection surface 1100b. The projection surface 1100b may be flat or curved.

The control unit 730b drives the display element 30 according to an image signal input from outside, adjusts a light amount from the light source unit 1, and adjusts the zoom and focus of the projection optical system 800a.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide a display apparatus and a display system, each of which has a reduced size.

This application claims the benefit of Japanese Patent Application No. 2024-147153, which was filed on Aug. 29, 2024, and which is hereby incorporated by reference herein in its entirety.

What is claimed is:

1. A display apparatus comprising:
a light source;
a display element configured to modulate illumination light from the light source to generate image light; and
an optical system including an optical function unit configured to guide the illumination light to the display element and guide the image light to a projection side,
wherein in a first direction parallel to an effective modulation area of the display element, a width of the optical function unit is smaller than or equal to a width of the effective modulation area.

2. The display apparatus according to claim 1, wherein the effective modulation area is a rectangular area, and
wherein the first direction is a direction parallel to a short side of the rectangular area.

3. The display apparatus according to claim 1, wherein the following inequality is satisfied:
$$0 < L 1 / L 2 \leq 0.7$$
where L1 is a distance on an optical axis from a pupil position of the optical system to the optical function unit, and L2 is a distance on the optical axis from the pupil position to the display element.

4. The display apparatus according to claim 1, wherein the following inequality is satisfied:
$$1. \leq L 2 / H \leq 4.$$
where L2 is a distance on an optical axis from a pupil position to the display element, and H is a diagonal length of the effective modulation area of the display element.

5. The display apparatus according to claim 1, wherein the optical system includes an optical element having positive refractive power that is disposed closer to the display element than the optical function unit.

6. The display apparatus according to claim 5, wherein the optical element has a largest width in the first direction in the optical system.

7. The display apparatus according to claim 5, wherein the following
$$ff / f \leq 2.5$$
where ff is a focal length of the optical element, and f is a focal length of the optical system.

8. The display apparatus according to claim 1, wherein the light source includes a light shielding member that has an opening of a similar shape to that of the display element and is optically conjugate with the display element.

9. The display apparatus according to claim 1, wherein the display element includes a reflective liquid crystal element.

10. A display apparatus comprising:
a light source;
a display element configured to modulate illumination light from the light source and generate image light; and
an optical system including an optical function unit configured to guide the illumination light to the display element and guide the image light to a projection side, and an optical element having positive refractive power disposed closer to the display element than the optical function unit,
wherein in a first direction parallel to an effective modulation area of the display element, a width of the optical function unit is smaller than a width of the optical element.

11. The display apparatus according to claim 10, wherein the optical element is an optical element having a largest width in the first direction in the optical system.

12. The display apparatus according to claim 10, wherein the optical element is an optical element having a smallest width in the first direction in the optical system.

13. The display apparatus according to claim 10, wherein the optical function unit is disposed closest to a projected position in the optical system.

14. A display system comprising:
a display apparatus according to claim 1,
wherein the display system causes an image formed by the image light emitted from the display apparatus to be visually recognized by an observer.

15. The display system according to claim 14, further comprising a light guide element configured to guide the image light emitted from the display apparatus to an observer's eye.

16. A display system comprising:
a display apparatus according to claim 10,
wherein the display system causes an image formed by the image light emitted from the display apparatus to be visually recognized by an observer.

17. The display system according to claim 16, further comprising a light guide element configured to guide the image light emitted from the display apparatus to an observer's eye.
